(19) United States
(12) Patent Application Publication
(10) Pub. No.: US 2026/0016572 A1
(43) Pub. Date: Jan. 15, 2026

(54) LIDAR CHIP AND LIDAR

(71) Applicant: Windsurf Technology (Wuxi) Ltd., Jiangsu (CN)

(72) Inventors: Xuezhe ZHENG, Jiangsu (CN); Chenlei LI, Jiangsu (CN)

(73) Assignee: Windsurf Technology (Wuxi) Ltd., Jiangsu (CN)

(21) Appl. No.: 18/994,059

(22) PCT Filed: Jun. 6, 2023
(86) PCT No.: PCT/CN2023/098488

§ 371 Date: Jan. 14, 2025

(30) Foreign Application Priority Data
Jul. 25, 2022 (CN) 202210874886.7

(51) Int. Cl. G01S 7/481

(52) U.S. Cl. CPC G01S 7/4814; G01S 7/4813

(57) ABSTRACT

A LiDAR chip includes an optical splitter, a beam splitter, a receiver and a transmitter, the transmitter includes an optical switch array and a grating coupler array, the grating coupler array is connected to the optical splitter and the receiver through the optical switch array and the beam splitter respectively. The optical splitter is connected to the receiver, and the beam splitter is connected to the optical splitter. The LiDAR chip through the optical splitter and outputs measurement light and local oscillation light to the transmitter and receiver respectively; by means of a corresponding optical switch, the optical switch array introduces into a corresponding grating coupler in the grating coupler array the measurement light which is then emitted by means of said grating coupler; a reflection echo received by a grating coupler is subjected to polarization splitting by means of the beam splitter and is then transmitted to the receiver.

This application claims the priority benefit of China application serial no. 202210874886.7, entitle “LIDAR CHIP and LIDAR”, filed on Jul. 25, 2022. The entirety of the above-mentioned patent application is hereby incorporated by reference herein and made a part of this specification.

### TECHNICAL FIELD

The present application relates to the field of LiDAR technology, particularly to a LiDAR chip and a LiDAR.

### DESCRIPTION OF RELATED ART

With the development of technology and continuous social progress, LiDAR technology has received increasing attention and has developed rapidly. Common all-solid-state LiDAR include optical phased array (OPA) LiDAR and focal plane switch array, and the two have unparalleled advantages over mechanical LiDAR in size, weight, and speed.

In the conventional all-solid-state LiDAR using the focal plane switch array, each angle within the field of view is mapped to a pixel on the focal plane, with each pixel consisting of only one optical antenna and one switch. The laser input from the light source can be output to any grating coupler unit of a transmission array through a cascaded switch array circuit. Therefore, by switching the light source input to different emitting grating channels through the switch array, the two-dimensional beam scanning required for LiDAR can be achieved. However, the conventional all-solid-state LiDAR using the focal plane switch array can only receive and process reflection light of a single polarization state, resulting in the loss of some information to be measured by the radar, so its detection range and accuracy are accordingly limited. How to provide a LiDAR that can improve detection range and accuracy is an urgent problem to be solved.

### SUMMARY

### Technical Problems

Based on the above, it is necessary to address the aforementioned issues by providing a LiDAR chip and a LiDAR capable of improving detection range and accuracy.

### Technical Solutions

A LiDAR chip includes an optical splitter, a beam splitter, a receiver, and a transmitter, the transmitter is a focal plane switch array transmitter, the transmitter includes an optical switch array and a grating coupler array, the optical switch array includes a plurality of optical switches, the grating coupler array includes a plurality of grating couplers, the grating coupler array is connected to the optical splitter by means of the optical switch array, the optical splitter is connected to the receiver, the grating coupler array is connected to the receiver by means of the beam splitter, and the beam splitter is connected to the optical splitter.

The LiDAR chip receives a laser signal, outputs measurement light to the focal plane switch array transmitter by means of the optical splitter, and outputs local oscillation light to the receiver by means of the optical splitter.

The optical switch array introduces the measurement light into a corresponding grating coupler in the grating coupler array by means of a corresponding optical switch, and the measurement light is then emitted by means of the grating coupler,

A reflection echo received by the grating coupler is subjected to polarization splitting by means of the beam splitter and is then transmitted to the receiver.

The grating couplers are dual-polarization grating couplers.

In one of the embodiments, the LiDAR chip further includes an echo coupler, and the echo coupler is connected to the optical splitter, the optical switch array, and the beam splitter. The echo coupler transmits the measurement light transmitted from the optical splitter to the optical switch array and transmits the reflection echo received by the optical switch array from the grating coupler to the beam splitter.

In one of the embodiments, the optical switches are dual-polarization optical switches.

In one of the embodiments, each of the dual-polarization optical switches includes an input port, a first output port, and a second output port. The input port is connected to the first output port of the previous-stage dual-polarization optical switch or the echo coupler, and the second output port is connected to the input port of the next-stage dual-polarization optical switch or the grating coupler. The dual-polarization optical switch receives the measurement light through the input port and outputs the measurement light through one of the first output port and the second output port. The dual-polarization optical switch outputs the measurement light through the first output port when in a first state, and the dual-polarization optical switch outputs the measurement light through the second output port when in a second state.

In one of the embodiments, light split by the beam splitter is mixed with the local oscillator light and then transmitted to the receiver.

In one of the embodiments, the dual-polarization grating coupler is a polarization-insensitive grating coupler, a single port of the polarization-insensitive grating coupler is connected to the dual-polarization optical switch, and the polarization-insensitive grating coupler outputs received light with TE and TM polarization states to the dual-polarization optical switch.

In one of the embodiments, the dual-polarization grating coupler is a polarization beam-splitting grating, the transmitter further includes a polarization beam combiner, both ports of the polarization beam-splitter grating are connected to the polarization beam combiner, and the polarization beam combiner is connected to the dual-polarization optical switch. The dual polarization grating coupler converts received light with TE and TM polarization states into TE polarized light and transmits the TE polarized light to the polarization beam combiner, and the polarization beam combiner performs polarization beam combining on the two TE polarized light beams and outputs the TE and TM polarized light to the dual-polarization optical switch.

In one of the embodiments, the dual-polarization optical switch is a phase-change material optical switch.

In one of the embodiments, the phase-change material optical switch is in the first state/second state when a phase-change material is in a crystalline state, and the phase-change material optical switch is in the second state/first state when the phase-change material is in an amorphous state. A switching control method of the crystalline state and the amorphous state of the phase-change material comprises external electrode heating, laser pulse stimulation, or electric pulse stimulation.

In one of the embodiments, the LiDAR chip is further provided with electrical contact points electrically connected to an external processor, and the electrical contact points are electrically connected to the receiver and the optical switches.

A LiDAR includes a housing, a laser arranged in the housing, a processor, a collimating lens system, and the aforementioned LiDAR chip. The laser provides a laser signal to the LiDAR chip, the processor is used to control operations of the laser and the LiDAR chip, and the collimating lens system guides light emitted from the LiDAR chip outwards.

### Beneficial Effects

In the LiDAR chip and the LiDAR, the dual-polarization grating coupler is used in the focal plane switch array transmitter to transmit and receive signals, so polarization-insensitive detection is implemented, and the detection distance and accuracy of the LiDAR are effectively increased and improved.

### BRIEF DESCRIPTION OF THE DRAWINGS

To make the technical solutions provided in the embodiments of the present application or the related art more clearly illustrated, several accompanying drawings required by the embodiments or the related art for description are briefly introduced as follows. Obviously, the drawings in the following description are merely some embodiments of the present application, and for a person having ordinary skill in the art, other drawings can be obtained based on these drawings without an inventive effort.

FIG. 1 is a structural block diagram of a LiDAR chip in an embodiment.

FIG. 2 is a structural block diagram of the LiDAR chip in another embodiment.

FIG. 3 is a structural view of a principle of the LiDAR chip in an embodiment.

FIG. 4 is a schematic side view of beam scanning of a phase-change material optical switch in an embodiment.

FIG. 5 is a schematic view of an optical switch unit in an “ON” state in an embodiment.

FIG. 6 is a schematic view of the optical switch unit in an “OFF” state in an embodiment.

FIG. 7 is a schematic view of a principle of a dual-polarization grating coupler in an embodiment.

FIG. 8 is a schematic view of the principle of the dual-polarization grating coupler in another embodiment.

FIG. 9 is a structural view of the principle of the LiDAR chip in another embodiment.

FIG. 10 is a schematic structural view of the phase-change material optical switch in an embodiment.

FIG. 11 is a cross-sectional view of the phase-change material optical switch taken along A-A′ in FIG. 10.

FIG. 12 is a cross-sectional view of the phase-change material optical switch taken along B-B′ in FIG. 10.

FIG. 13 is a cross-sectional view of the phase-change material optical switch taken along C-C′ in FIG. 10.

FIG. 14 is a schematic structural view of the phase-change material optical switch in another embodiment.

FIG. 15 is a cross-sectional view of the phase-change material optical switch taken along A-A′ in FIG. 14.

FIG. 16 is a cross-sectional view of the phase-change material optical switch taken along B-B′ in FIG. 14.

FIG. 17 is a cross-sectional view of the phase-change material optical switch taken along C-C′ in FIG. 14.

### DESCRIPTION OF THE EMBODIMENTS

In order to make the objectives, technical solutions, and advantages of the present application clearer and more comprehensible, the present application is further described in detail with reference to the drawings and embodiments. It should be understood that the specific embodiments described herein serve to explain the present application merely and are not used to limit the present application.

Unless otherwise defined, all technical and scientific terms used in the specification have the same meaning as commonly understood by a person having ordinary skill in the art. The terms used herein in the specification of the present application are for the purpose of describing specific embodiments only, and are not intended to limit the present application.

It can be understood that “connection” in the following embodiments should be understood as “electrical connection”, “communication connection”, etc. if the connected circuits, modules, units, etc. have the transmission of electrical signals or data between each other.

The rapid development in fields such as autonomous driving, space optical communication, and bio-sensing has continuously driven the advancement of three-dimensional imaging technology, so LiDAR technology has received increased attention and has developed rapidly. LiDAR beam control may be achieved through mechanical methods. However, to achieve LiDAR with large aperture, high resolution, and low loss, all-solid-state LiDAR is required. Common all-solid-state LiDAR includes optical phased array (OPA) LiDAR and focal plane switch array, and the two have unparalleled advantages over mechanical LiDAR in size, weight, and speed.

However, implementation of LiDAR with large-angle and high-resolution beam scanning using OPA not only requires precise phase control but also faces several challenges that need to be overcome. 1) The beam scanning range of OPA is limited by its output beam sidelobes. To eliminate sidelobes, the spacing between phased array transmitting antenna units theoretically needs to be less than ½ wavelength. Even when using waveguide gratings as emitting units, the waveguide spacing generally needs to be much larger than the optical wavelength to effectively suppress crosstalk between emitting units. Although using randomly spaced waveguide grating arrays may suppress sidelobes to some extent, noise is inevitably increased. 2) Achieving high-resolution beam scanning requires a large aperture OPA. To suppress the influence of sidelobes, the spacing between emitting antenna units needs to be as small as possible, which leads to a large-scale OPA array. Two-dimensional OPAs often require tens of thousands or even hundreds of thousands of phase-controlled emitting units, making engineering implementation extremely challenging. Therefore, existing OPAs typically use a scheme of one-dimensional phase-controlled waveguide array plus waveguide grating output array, so as to achieve scanning in one dimension direction through waveguide phase control and achieve scanning in the second dimension by changing the output angle of the waveguide grating due to changes in the optical wavelength. The problem is that to achieve the scanning range required for LiDAR, such as 30°, a very wide range of wavelength tuning is needed, such as 200 nm. Such a wide-range tunable laser is expensive and difficult to meet the needs of LiDAR products.

The method of using a focal plane switch array to achieve the beam scanning required for LiDAR may well avoid the aforementioned problems of OPA. It maps each angle in the field of view to a pixel on the focal plane, with each pixel consisting of only one optical antenna and one switch (which helps to improve monolithic integration). The laser input from the light source can be output to any grating coupler unit of a transmission array through a cascaded switch array circuit. By placing the transmission array at the focal plane position of a collimating lens, the beams emitted from different gratings form collimated beams at different angles after passing through the lens due to their different positions relative to the lens optical axis. Therefore, by switching the light source input to different emitting grating channels through the switch array, the two-dimensional beam scanning required for LiDAR can be achieved.

Common switch arrays include MZI (Mach-Zehnder Interferometer) optical switches and MEMS (Micro-Electro-Mechanical System) optical switches. LiDAR implementations using cascaded MZI optical switches often adopt thermal tuning methods. Due to the inherent working nature of MZI optical switches, they are mainly limited by size and high power consumption, making it difficult to achieve a large number of channels on a single chip. MEMS optical switches have advantages such as small size, low power consumption, and fast switching speed. However, MEMS optical switches on silicon substrates have very high process requirements.

In addition, whether it is an optical phased array LiDAR or a focal plane optical switch array LiDAR, due to the polarization selectivity of the waveguide and coupling grating, the receiving end may only process single-polarization (e.g., TE (Transverse Electric Wave) mode) information. However, for an object to be measured, even if the incident light is in a single polarization mode, its reflected light from different object surfaces may no longer be in a single polarization state. If only single-polarization reflected light can be received and processed, the LiDAR may lose some of the information to be measured, and its detection range and accuracy may be correspondingly limited.

Therefore, to achieve a large-aperture, high-resolution, and fast all-solid-state LiDAR while reducing device size, lowering power consumption, achieving more array units to achieve a larger field of view and scanning precision, as well as considering information from both polarization states to improve system precision and accuracy, are the key issues that urgently need to be solved for current all-solid-state LiDAR.

The aforementioned deficiencies of the aforementioned OPA technical solution and focal plane switch array technical solution are mainly due to complex design and process, large array unit size, high power consumption, and other problems. Moreover, whether it is an optical phased array LiDAR or a focal plane optical switch array LiDAR, due to the polarization selectivity of the waveguide and coupling grating, the receiving end may only process single-polarization (e.g., TE mode) information, so the precision and accuracy of the LiDAR are limited.

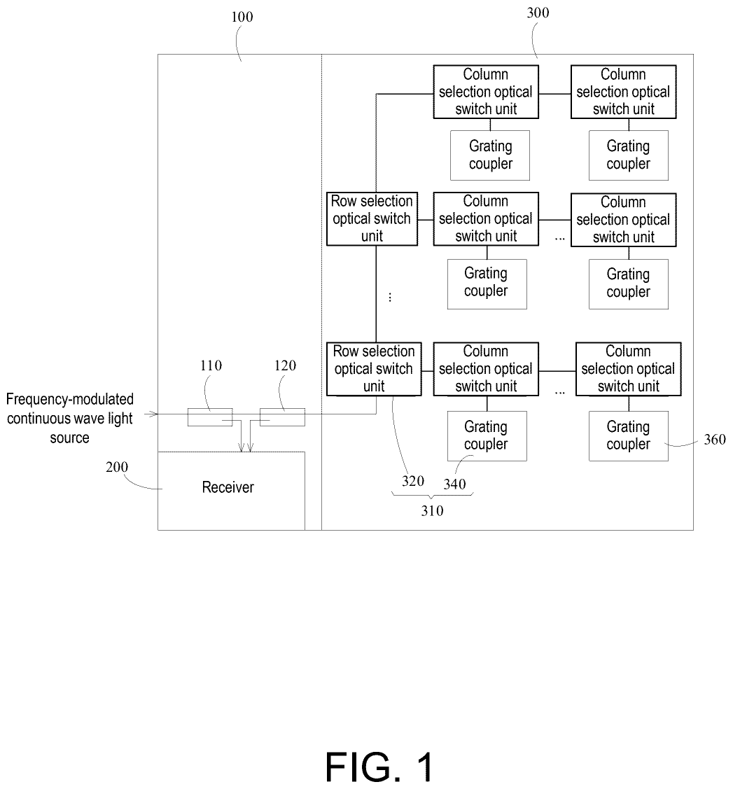

In an embodiment, a LiDAR chip is provided, and as shown in FIG. 1, a LiDAR chip 100 includes an optical splitter 110, a beam splitter (not shown), a receiver 200, and a transmitter 300. The transmitter 300 is a focal plane switch array transmitter, and the transmitter 300 includes an optical switch array and a grating coupler array. The optical switch array includes a plurality of optical switches 310, and the grating coupler array includes a plurality of grating couplers 360, the grating coupler array is connected to the optical splitter 110 by means of the optical switch array, and the optical splitter 110 is connected to the receiver 200, the grating coupler array is connected to the receiver 200 by means of the beam splitter, and the beam splitter is connected to the optical splitter 110. The LiDAR chip 100 receives a laser signal, outputs measurement light to the focal plane switch array transmitter by means of the optical splitter 110, and outputs local oscillation light to the receiver 200 by means of the optical splitter 110. The optical switch array introduces the measurement light into a corresponding grating coupler 360 in the grating coupler array by means of a corresponding optical switch 310, and the measurement light is then emitted by means of the grating coupler 360. A reflection echo received by the grating coupler 360 is subjected to polarization splitting by means of the beam splitter and is then transmitted to the receiver 200. The type of grating coupler 360 in the transmitter 300 is not unique, it may be a single-polarization grating coupler or a dual-polarization grating coupler. In this embodiment, the grating coupler 360 adopts a dual-polarization grating coupler, and the dual-polarization grating coupler refers to a grating coupler that can receive two types of polarized waves.

Further, the LiDAR chip 100 also includes an echo coupler 120, and the echo coupler 120 is connected to the optical splitter 110, the optical switch array, and the beam splitter. The echo coupler 120 transmits the measurement light from the optical splitter 110 to the optical switch array and transmits the reflection echo received by the optical switch array from the grating coupler 360 to the beam splitter. The reflection echo received by the grating coupler 360 may be directly transmitted to the beam splitter connected to the receiver 200, or it may be transmitted to the beam splitter connected to the receiver 200 through the optical switch array. In this embodiment, the reflection echo received by the grating coupler 360 is transmitted to the beam splitter through the optical switch array, and the optical switch array is a dual-polarization optical switch array. That is, the optical switches 310 in the optical switch array adopt dual-polarization optical switches, and a dual-polarization optical switch refers to an optical switch that allows two types of polarized waves to pass through. The focal plane switch array transmitter uses dual-polarization optical switches to control an optical path of the transmission of the measurement light and uses dual-polarization grating couplers for signal transmission and reception, so polarization-insensitive detection is achieved through optical path control.

Herein, according to the different positions of the optical switches 310 in the transmitter 300, the optical switches 310 may be divided into row selection optical switch units 320 and column selection optical switch units 340. The specific type of the optical switches 310 is not unique, and in an embodiment, the optical switches 310 are phase-change material optical switches. Each phase-change material optical switch is made of a phase-change material and other waveguide materials. When subjected to external stimuli, a phase-change material may alternate between a crystalline state and an amorphous state, and the refractive index and material loss of the phase-change material in the crystalline state and the amorphous states may also change. Therefore, when the state of the phase-change material changes, the corresponding effective refractive indexes in the phase change material waveguide and the hybrid waveguide composed of other waveguide materials are different. Using this principle, the phase-change material optical switch may be controlled to switch between phase-matched and phase-mismatched states, corresponding to an “ON” or “OFF” state of each switch, so that the control of the transmission optical path of the measurement light is achieved.

Using phase-change material optical switches for switching may reduce device size and lower power consumption compared to MZI optical switches. Herein, the switching speed of the phase-change material optical switch may reach nanosecond level, and the switching frequency may reach GHz. Therefore, even horizontal beam scanning with thousands of sampling points may be completed at the microsecond level. Meanwhile, the power consumption of the phase-change material optical switches is effectively reduced compared to thermally-controlled cascaded MZI optical switches. The entire LiDAR transmission and reception may be implemented on a single chip with a relatively small size. Large-angle, high-quality, and two-dimensional beam scanning may be achieved using a single wavelength, so that low costs and high reliability are achieved. In this embodiment, phase-change material optical switches are used to control the optical path of transmission of the measurement light. The switches have fast switching speed and low power consumption, so that multi-channel beam scanning may be rapidly completed. This may support the expansion of multiple channels on a single LiDAR chip, so more array units on a single LiDAR chip and a larger field of view and scanning accuracy are achieved.

In addition, the LiDAR chip 100 is a PIC (Photonic Integrated Circuit) single-chip, which may specifically form the receiver 200 and the transmitter 300 on an SOI (Silicon-On-Insulator) substrate. Further, the LiDAR chip 100 is also provided with electrical contact points that are electrically connected to an external processor, and the electrical contact points are electrically connected to the receiver 200 and the optical switches 310.

In an embodiment, light split by the beam splitter is mixed with the local oscillator light and then transmitted to the receiver 200. To be specific, the LiDAR chip 100 splits a linear frequency-modulated continuous wave laser signal with a wavelength λ to obtain the measurement light and the local oscillation light. The receiver 200 performs frequency mixing and balanced light detection processing on the local oscillation light and the light after polarization splitting by the beam splitter to obtain target object information. Further, the beam emitted from the grating coupler 360 is transmitted to a target object after passing through a collimating lens system of the LiDAR, and the reflection echo from the target object returns to the grating coupler 360 after passing through the collimating lens system. Herein, the LiDAR chip 100 is located at a focal plane of the collimating lens system. The receiver 200 may adopt a coherent detection receiver. After determining the optical path for transmitting the measurement light by switching the state of the relevant phase-change material optical switches in the focal plane switch array transmitter, the measurement light is delivered along the optical path to the corresponding grating coupler 360 and emitted from a surface of the LiDAR chip 100. The emitted beam is collimated by the collimating lens system placed above the LiDAR chip 100, forming radar scanning beams in different spatial directions. After the measurement light enters the focal plane switch array transmitter, by controlling the row selection optical switch unit 320 and the column selection optical switch unit 340, it may be switched to emit vertically from the surface of the LiDAR chip 100 through the grating coupler 360 of any array unit. The reflection echo formed after the radar scanning beam is reflected by the target object returns through the same optical path to enter the receiver 200, and the receiver 200 processes the signal based on the reflection echo and the local oscillation light to obtain target object information, so the detection of the target object is implemented. For instance, the receiver 200 mixes the reflection echo with the local oscillation light and then performs balanced optical detection to achieve the detection of the spatial position, distance, and moving speed of the target object. The echo coupler 120 may be a 50/50 split optical coupler or a circulator to reduce optical loss. After a reflection echo signal is mixed with the local oscillation light, balanced optical detection may be implemented to achieve the detection of the spatial position, distance, and moving speed of the target object.

In an embodiment, as shown in FIG. 1, the optical switch 310 includes row selection optical switch units 320 and column selection optical switch units 340. The row selection optical switch units 320 are connected in sequence and then connected to the receiver 200 through the echo coupler 120. Each row selection optical switch unit 320 is connected to two or more column selection optical switch units 340 that are connected in sequence, and each column selection optical switch unit 340 is connected to one corresponding grating coupler 360. Herein, the row selection optical switch units 320 may be arranged in the same row with their corresponding column selection optical switch units 340, and the column selection optical switch units 340 in the same row are connected in sequence and then connected to the corresponding row selection optical switch unit 320. The row selection optical switch units 320 and column selection optical switch units 340 are arranged in an array to form a focal plane switch array. Optical signals are transmitted between optical switch units through array waveguides, and the array waveguides may be silicon array waveguides or silicon nitride array waveguides. The array waveguides may be in the silicon layer of an SOI substrate through free-space sub-wave focusing and combining, or the optical signals of the array waveguides may first be coupled to a dielectric layer waveguide placed above it and then focused and combined through the free-space sub-waves in the dielectric layer.

As shown in FIG. 1, among the row selection optical switch units 320 connected in sequence, the row selection optical switch unit 320 located on the side far from the receiver 200, i.e., the row selection optical switch unit 320 at the very end, may be referred to as the end row selection optical switch unit 320 according to the connection relationship. Other row selection optical switch units that are not at the end may be referred to as non-end row selection optical switch units 320. In an embodiment, the non-end row selection optical switch units 320 are connected to a series of column selection optical switch units 340 connected in sequence. When the non-end row selection optical switch units 320 are in a first state, the measurement light is transmitted to the next row selection optical switch unit 320, and when the non-end row selection optical switch units are in a second state, the measurement light is transmitted to the corresponding column selection optical switch unit 340.

The end row selection optical switch unit 320 is connected to two series of column selection optical switch units 340 connected in sequence. When the end row selection optical switch unit 320 is in the first state, the measurement light is transmitted to one series of the column selection optical switch units 340, and when the end row selection optical switch unit 320 is in the second state, the measurement light is transmitted to the other series of the column selection optical switch units 340. When the column selection optical switch units 340 are in the first state, the measurement light is transmitted to the next column selection optical switch unit 340, and when the column selection optical switch units 340 are in the second state, the measurement light is transmitted to the corresponding grating coupler 360.

Herein, the column selection optical switch units 340 in the same series are arranged in the same row, and the end row selection optical switch unit 320 is connected to two column selection optical switch units 340. In other words, the number of row selection optical switch units 320 may be one less than the number of rows in the focal plane switch array. By switching the state of the end row selection optical switch unit 320, light transmission control for two rows may be achieved, and costs are thereby decreased.

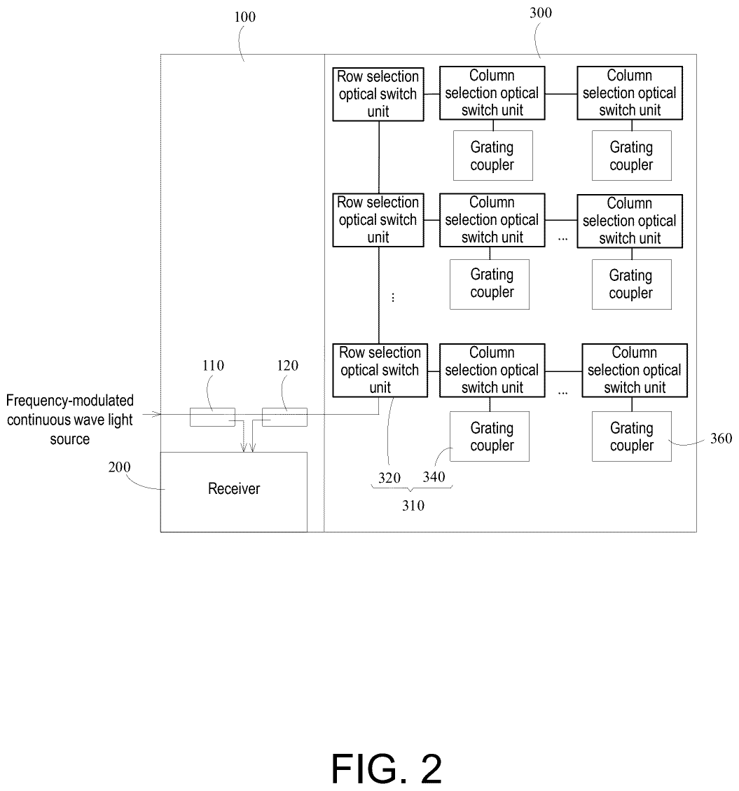

In another embodiment, as shown in FIG. 2, the end row selection optical switch unit 320 is connected to a series of column selection optical switch units 340 connected in sequence, the end row selection optical switch unit 320 is set to the second state, and the measurement light is transmitted to the corresponding column selection optical switch unit 340. It may be understood that the switching principle of the non-end row selection optical switch units 320 and the column selection optical switch units 340 in different rows is similar to that described above, so description thereof is not repeated herein. In this embodiment, one row selection optical switch unit 320 is arranged for each row of the corresponding focal plane switch array, the end row selection optical switch unit 320 may be fixedly set to the second state, and the received measurement light may be directly transmitted to the corresponding column selection optical switch unit 340.

Herein, both the row selection optical switch units 320 and the column selection optical switch units 340 are optical switch units using phase-change material. It may be understood that, depending on the different connection relationships of the optical switch units in the focal plane switch array transmitter, the correspondence between the selection state of the optical switch units and the transmission direction of the measurement light may also differ. That is, the first state may correspond to the “ON” /“OFF” state of the corresponding optical switch unit, while the second state may correspond to the “OFF” /“ON” state of the corresponding optical switch unit.

To be specific, the state of the phase change material optical switch may be controlled by controlling the phase change material to switch between the crystalline state and the amorphous state. In an embodiment, the phase-change material optical switch is in the first state/second state when the phase-change material is in the crystalline state, and the phase-change material optical switch is in the second state/first state when the phase-change material is in the amorphous state. A state switching method for the phase-change material includes external electrode heating, laser pulse stimulation, or electrical pulse stimulation. Herein, the “ON” (“OFF”) state of the phase-change material optical switch may correspond to either the crystalline state or the amorphous state, as long as a waveguide size of the phase-change material waveguide in the phase-change material optical switch satisfies the phase matching (mismatch) conditions. External stimulation methods such as external electrode heating, laser pulse stimulation, or electrical pulse stimulation may be used to alternately change the phase-change material between the crystalline state and the amorphous state, so the state switching of the phase-change material optical switch is achieved.

For ease of understanding, the following explanation uses the example where the first state of the phase-change material optical switch is the “ON” state, and the second state is the “OFF” state.

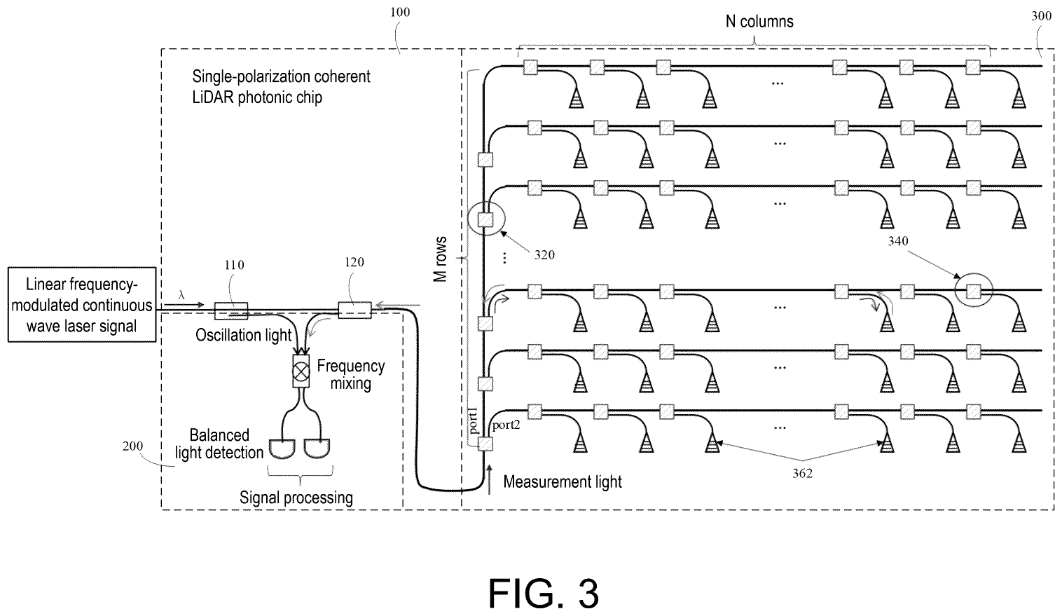

As shown in FIG. 3, when the grating coupler 360 adopts a single-polarization grating coupler 362, the LiDAR chip 100 is a single-polarization coherent LiDAR photonic chip. The linear frequency-modulated measurement light passes through the row selection optical switch unit 320. When the row selection optical switch unit 320 is in the “ON” state, the optical signal passes directly through the row selection optical switch unit 320 without changing its direction, and the optical signal continues to transmit vertically until it reaches the next row selection optical switch unit 320 for selection. When the row selection optical switch unit 320 is in the “OFF” state, the optical signal is coupled, and the optical signal enters the array row for horizontal transmission until it reaches the next column selection optical switch unit 340 for direction selection.

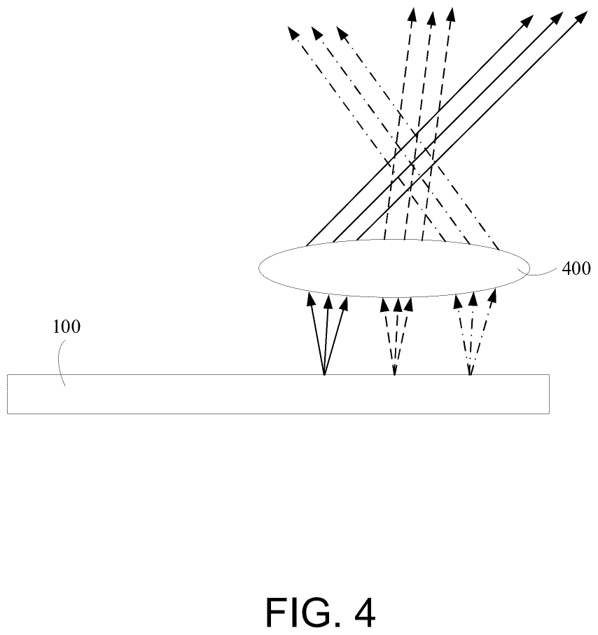

The measurement light coupled to the array row enters the column selection optical switch units 340 in sequence. When the column selection optical switch unit 340 is in the “ON” state, the optical signal continues to transmit along the horizontal channel, and when the column selection optical switch unit 340 is in the “OFF” state, the optical signal is coupled to the single-polarization grating coupler 362. The single-polarization grating coupler 362 vertically emits the optical signal, which is transmitting along the plane, from the surface of the LiDAR chip 100 into free space. As shown in FIG. 4, a collimating lens system 400 is placed in free space, with its distance from the single-polarization grating coupler 362 equal to a focal length of a lens. The collimating lens system 400 may specifically include a lens, and the optical signal emitted from the single-polarization grating coupler 362 is collimated by the lens and emitted towards the target object. By controlling the state of each optical switch unit, the measurement light may be emitted from M×N emission points and generates different scanning angles to scan the distant target object after passing through the collimating lens system 400. Correspondingly, after receiving the reflection echo, the receiver 200 mixes the reflection echo with the local oscillation light to obtain two optical signals. Based on these two optical signals, balanced optical detection is performed to obtain the target object information, and the detection of the target object is thus implemented.

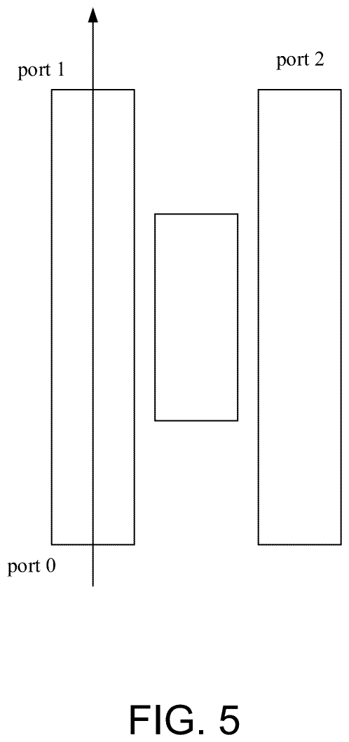

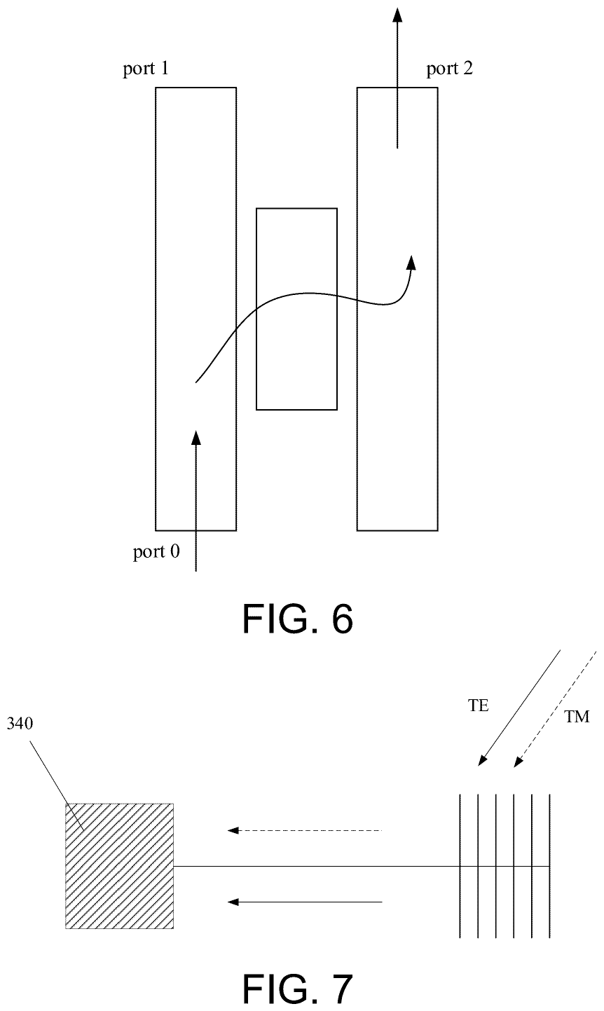

In an embodiment, as shown in FIG. 5 and FIG. 6, the dual-polarization optical switch includes an input port0, a first output port1, and a second output port2. The input port0 is connected to the first output port1 of the previous-stage dual-polarization optical switch or the echo coupler 120, and the second output port2 is connected to the input port0 of the next-stage dual-polarization optical switch or the grating coupler 360. The dual-polarization optical switch receives the measurement light through the input port0 and outputs the measurement light through either the first output port1 or the second output port2. When the dual-polarization optical switch is in the first state, it outputs the measurement light through the first output port1, and when the dual-polarization optical switch is in the second state, it outputs the measurement light through the second output port2. To be specific, in the sequentially-connected row selection optical switch units 320, the input port0 of the first row selection optical switch unit 320 is connected to the echo coupler 120. The first output port1 of the first row selection optical switch unit 320 is connected to the input port0 of the next row selection optical switch unit 320. The second output port2 of the first row selection optical switch unit 320 is connected to the input port0 of the first column selection optical switch unit 340 in the same row. The first output port1 of the first column selection optical switch unit 340 in the same row is connected to the input port0 of the next column selection optical switch unit 340. The second output port2 of the first column selection optical switch unit 340 in the same row is connected to the corresponding grating coupler 360. It may be understood that, except for the last row selection optical switch unit 320 and the last column selection optical switch unit 340, the connection relationships of the two output ports of the row selection optical switch units 320 cascaded after the first row selection optical switch unit 320 are similar to those of the first row selection optical switch unit 320. Similarly, the connection relationships of the two output ports of the column selection optical switch units 340 cascaded after the first column selection optical switch unit 340 in the same row are similar to those of the first column selection optical switch unit 340, so description thereof is not repeated herein.

Similarly, taking the row selection optical switch unit 320 and the column selection optical switch unit 340 as examples of optical switch units using the phase-change material, when the optical switch unit is in the “ON” state, the optical signal input from the input port0 of the optical switch unit is directly output through the first output port1 of the optical switch unit without changing its direction. When the optical switch unit is in the “OFF” state, the optical signal is coupled from the input port0 to the second output port2 for output. For instance, when the row selection optical switch unit 320 is switched to the “OFF” state, the optical signal is coupled from the input port0 to the second output port2 for output, and the optical signal enters the array row for horizontal transmission to reach the column selection optical switch unit 340 for direction selection. If the column selection optical switch unit 340 is in the “OFF” state, the optical signal is coupled to the second output port2 of the column selection optical switch unit 340 connected to the single-polarization grating coupler 362.

In an embodiment, the grating couplers 360 are dual-polarization grating couplers. To be specific, the row selection optical switch unit 320 and the column selection optical switch unit 340 are both phase-change material dual-polarization optical switch units. The dual-polarization optical switch unit may be implemented through the selection of waveguide thickness and width of the optical switch unit. That is, under a specific waveguide cross-section design, corresponding to the “ON” or “OFF” state of the optical switch unit, both TE and TM (Transverse Magnetic Wave) modes can satisfy the phase matching or phase mismatch condition. In other words, in the “ON” (“OFF”) state, both TE and TM polarization states can be output simultaneously from the port1 (port2) of the optical switch unit. Herein, the dual-polarization grating coupler may be a single-port or dual-port dual-polarization grating coupler. The single-port dual-polarization grating coupler may be directly connected to the corresponding column selection optical switch unit 340, while the dual-port dual-polarization grating coupler may be connected to the corresponding column selection optical switch unit 340 through a polarization beam combiner. When the grating coupler 360 uses a dual-polarization grating coupler, after receiving the reflection echo, the receiver 200 mixes the reflection echo with the local oscillation light to obtain four optical signals. Based on these four optical signals, balanced optical detection is performed to obtain the target object information, and the detection of the target object is thus implemented.

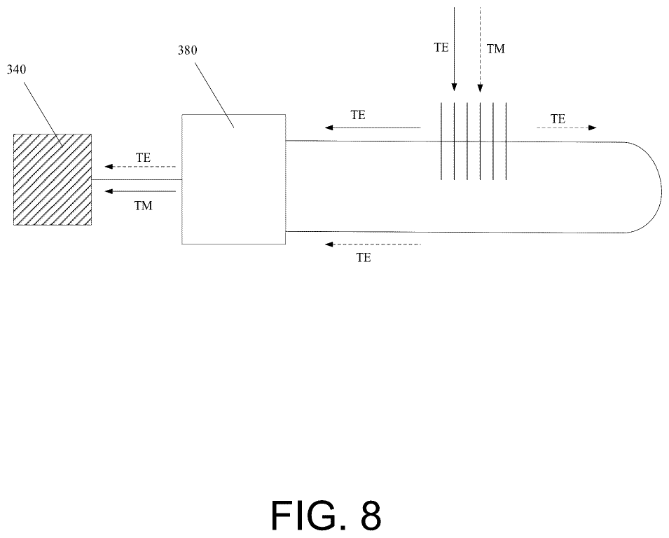

To be specific, the connection between the dual-polarization grating coupler and the dual-polarization optical switch unit may have two connection approaches as shown in FIG. 7 and FIG. 8.

In an embodiment, as shown in FIG. 7, the dual-polarization grating coupler is a polarization-insensitive grating coupler. A single port of the polarization-insensitive grating coupler is connected to the dual-polarization optical switch, and the polarization-insensitive grating coupler outputs received light with TE and TM polarization states to the dual-polarization optical switch. To be specific, when the dual-polarization grating coupler is a polarization-insensitive grating coupler with single-port output, i.e., when the incident light has both TE and TM polarization states, and the light coupled to the SOI chip outputs both TE and TM polarizations from one port, this port may be directly connected to the phase-change material-based column selection optical switch unit 340. Both TE and TM polarization states pass through the column selection optical switch unit 340 and return along the original optical path to the receiver 200.

In another embodiment, as shown in FIG. 8, the dual-polarization grating coupler may be a polarization beam-splitting grating, and the transmitter 300 may further include a polarization beam combiner 380. The dual ports of the polarization beam splitting grating are connected to the polarization beam combiner 380, and the polarization beam combiner 380 is connected to the dual-polarization optical switch. The dual-polarization grating coupler converts the received light with TE and TM polarization states into TE polarized light and transmits the TE polarized light to the polarization beam combiner 380. The polarization beam combiner 380 performs polarization beam combining on the two TE polarized light beams and outputs the TE and TM polarized light to the dual-polarization optical switch. To be specific, when the dual-polarization grating coupler is a polarization beam-splitting grating with dual-port output, i.e., TE/TM polarizations are output separately in the TE mode from two ports of the grating coupler, an inverted polarization beam splitter—the polarization beam combiner 380—is needed. The two TE components are combined through the polarization beam combiner 380 to output TE/TM from the same port. The output port of the polarization beam combiner 380 is then connected to the column selection optical switch unit 340, allowing the measurement signal to return along the original path to the receiver 200.

In this embodiment, the row selection optical switch unit 320 and the column selection optical switch unit 340 are designed as dual-polarization optical switch units, and the grating coupler 360 is selected as a dual-polarization grating coupler. The transmitter 300 may receive both TE and TM components of a reflection light signal from the target object, so the polarization-insensitive detection is implemented, optimal detection sensitivity and range are achieved, and the detection precision and accuracy for both polarization states are balanced.

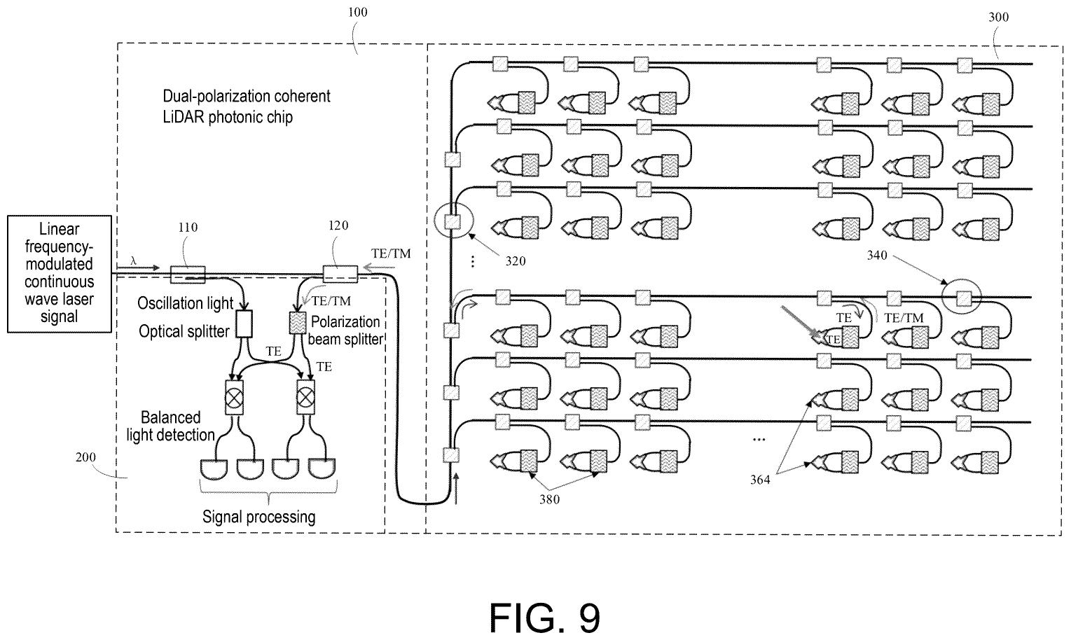

In an embodiment, as shown in FIG. 9, both the row selection optical switch unit 320 and the column selection optical switch unit 340 are phase-change material dual-polarization optical switch units, and the grating coupler 360 is a dual-polarization grating coupler 364, making the LiDAR chip 100 a dual-polarization coherent LiDAR photonic chip. The transmitter 300 further includes the polarization beam combiner 380, with each dual-polarization grating coupler 364 connected to the corresponding column selection optical switch unit 340 through one polarization beam combiner 380. The dual-polarization grating coupler 364 acts as the focal plane switch array transmitter and is connected to a cross port of the column selection optical switch unit 340 through the polarization beam combiner 380. After the echo signal containing the TE and TM components enters the receiver 200, the TE and TM components are separated by the polarization beam splitter and are mixed with the split local oscillation light and balanced light for detection respectively. The two polarization component signals detected are finally synthesized into a LiDAR detection signal through digital signal processing.

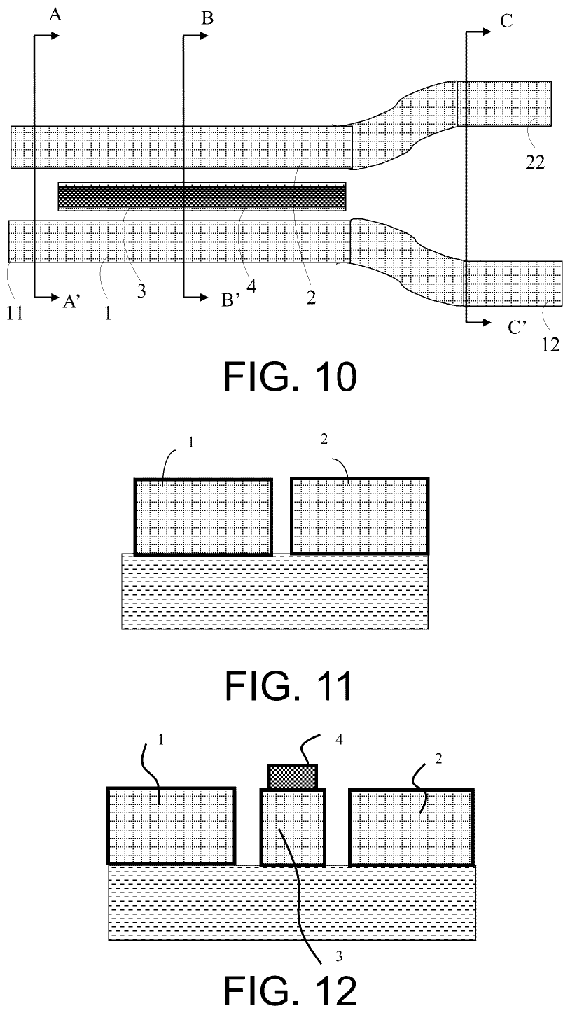

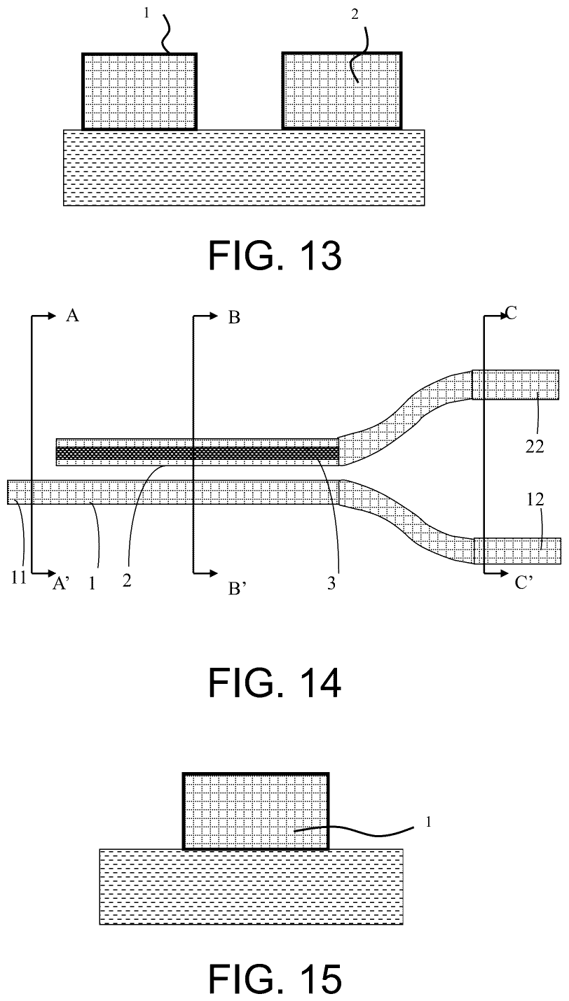

In an embodiment, when the dual-polarization optical switch adopts a phase-change material optical switch, the phase-change material optical switch may specifically include an input waveguide and an output waveguide arranged side by side and a coupling waveguide located between the input waveguide and the output waveguide. The coupling waveguide is located between the input waveguide and the output waveguide, and the coupling waveguide is a hybrid waveguide with the phase-change material. One port of the input waveguide forms the input port0, while the other port forms the first output port1. One port of the output waveguide adjacent to the first output port1 forms the second output port2. The coupling waveguide is used to selectively guide the light entering from the input port0 to either the first output port1 or the second output port2. Herein, the specific types of the input waveguide and the output waveguide are not unique, the input waveguide may be a silicon waveguide or a silicon nitride waveguide, and the output waveguide may also be a silicon waveguide or a silicon nitride waveguide. Correspondingly, the coupling waveguide may be a hybrid waveguide composed of a phase-change material waveguide and a silicon waveguide, i.e., the hybrid waveguide is composed of a silicon waveguide with a phase-change material waveguide covered on top. In this embodiment, the coupling waveguide includes a waveguide layer and a phase-change material layer formed above the waveguide layer. As shown in FIG. 10 to FIG. 13, a waveguide 1, a waveguide 2, and a waveguide 3 are silicon waveguides or silicon nitride waveguides, while a waveguide 4 is a phase-change material waveguide. The waveguide 1 serves as the input waveguide of the phase-change material optical switch, the waveguide 2 serves as the output waveguide of the phase-change material optical switch, and the waveguide 3 and the waveguide 4 serve as the coupling waveguides.

To be specific, one port 11 of the waveguide 1 serves as the input port0 of the phase-change material optical switch, while the other port 12 serves as the first output port1 of the phase-change material optical switch. One port 22 of the waveguide 2 adjacent to the first output port1 serves as the second output port2 of the phase-change material optical switch. The coupling waveguide composed of the middle silicon waveguide and the phase-change material waveguide acts as an intermediate bridge for coupling. When the state of the phase-change material changes, the effective refractive indexes corresponding to different modes of the coupling waveguide composed of the phase-change material waveguide and the silicon waveguide are different. Utilizing this principle, the modes of the input waveguide and the output waveguide can switch between phase-matched and phase-mismatched states with the modes of the hybrid waveguide. This means the optical signal is alternately outputted at the first output port1 and the second output port2, corresponding to the “ON” or “OFF” state of the switch.

In another embodiment, the phase-change material optical switch includes an input waveguide and an output waveguide, where the output waveguide is a hybrid waveguide with the phase-change material. One port of the input waveguide forms the input port0, while the other port forms the first output port1. One port of the output waveguide adjacent to the first output port1 forms the second output port2. The output waveguide is used to selectively guide the light entering from the input port0 to either the first output port1 or the second output port2. Herein, the input waveguide may be a silicon waveguide or a silicon nitride waveguide, while the output waveguide may be a hybrid waveguide composed of a phase-change material waveguide and a silicon waveguide. In this embodiment, the output waveguide includes a waveguide layer and a phase-change material layer formed above the waveguide layer. Furthermore, the input waveguide includes an input section, an input coupling section, and a first output section, while the output waveguide includes an output coupling section and a second output section. The input coupling section and the output coupling section have comparable lengths and are arranged side by side. The phase-change material layer is located on the output coupling section, and port portions of the first output section and the second output section form the first output port1 and the second output port2, respectively.

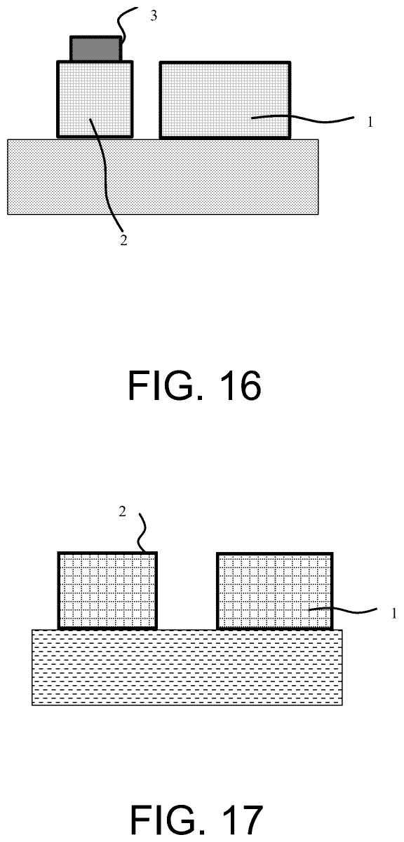

As shown in FIG. 14 to FIG. 17, the waveguide 1 and the waveguide 2 are silicon waveguides or silicon nitride waveguides, while the waveguide 3 is a phase-change material waveguide. The waveguide 1 serves as the input waveguide of the phase-change material optical switch, and the waveguide 2 and the waveguide 3 serve as the output waveguides of the phase-change material optical switch To be specific, one port 11 of the waveguide 1 serves as the input port0 of the phase-change material optical switch, while the other port 12 serves as the first output port1 of the phase-change material optical switch. One port 22 of the waveguide 2 adjacent to the first output port1 serves as the second output port2 of the phase-change material optical switch. The output waveguide is a hybrid waveguide composed of a silicon waveguide and a phase-change material. When the phase-change material transforms between the crystalline and amorphous states, due to mode matching and mode mismatching, the optical signal may pass through directly or couple into the output waveguide.

The above provides two different structures for the phase-change material optical switch. Compared to the structure shown in FIG. 14 to FIG. 17, the structure shown in FIG. 10 to FIG. 13 possesses the advantages of lower loss and higher extinction ratio.

In an embodiment, a LiDAR including a housing, a laser arranged in the housing, a processor, a collimating lens system, and the aforementioned LiDAR chip is provided. The laser provides a laser signal to the LiDAR chip, the processor is used to control operations of the laser and the LiDAR chip, and the collimating lens system guides light emitted from the LiDAR chip outwards.

The technical features of the above-described embodiments may be combined arbitrarily. In order to simplify the description, not all possible combinations of the technical features in the above embodiments are described. However, as long as there is no contradiction in the combinations of these technical features, these combinations should be considered to be within the scope of the description in this specification.

The abovementioned embodiments only represent several embodiments of the present application, and the descriptions thereof are specific and detailed, but should not be construed as a limitation on the scope of the invention patent. It should be pointed out that for a person having ordinary skill in the art, without departing from the concept of the present application, several modifications and improvements can be made, which all belong to the protection scope of the present application. Therefore, the protection scope of the patent of the present application should be subject to the appended claims.

1. A LiDAR chip, comprising an optical splitter, a beam splitter, a receiver, and a transmitter, wherein the transmitter is a focal plane switch array transmitter, the transmitter comprises an optical switch array and a grating coupler array, the optical switch array comprises a plurality of optical switches, the grating coupler array comprises a plurality of grating couplers, the grating coupler array is connected to the optical splitter by means of the optical switch array, and the optical splitter is connected to the receiver, the grating coupler array is connected to the receiver by means of the beam splitter, and the beam splitter is connected to the optical splitter,
the LiDAR chip receives a laser signal, outputs measurement light to the focal plane switch array transmitter by means of the optical splitter, and outputs local oscillation light to the receiver by means of the optical splitter,
the optical switch array introduces the measurement light into a corresponding grating coupler in the grating coupler array by means of a corresponding optical switch, and the measurement light is then emitted by means of the grating coupler,
a reflection echo received by the grating coupler is subjected to polarization splitting by means of the beam splitter and is then transmitted to the receiver,
the grating couplers are dual-polarization grating couplers.

2. The LiDAR chip according to claim 1, wherein the LiDAR chip further comprises an echo coupler, the echo coupler is connected to the optical splitter, the optical switch array, and the beam splitter, the echo coupler transmits the measurement light transmitted from the optical splitter to the optical switch array, and transmits the reflection echo received by the optical switch array from the grating coupler to the beam splitter.

3. The LiDAR chip according to claim 2, wherein the optical switches are dual-polarization optical switches.

4. The LiDAR chip according to claim 3, wherein each of the dual-polarization optical switches comprises an input port, a first output port, and a second output port, the input port is connected to a first output port of a previous-stage dual-polarization optical switch or an echo coupler, the second output port is connected to a input port of a next-stage dual-polarization optical switch or a grating coupler, the dual-polarization optical switch receives the measurement light through the input port, and outputs the measurement light through one of the first output port and the second output port, the dual-polarization optical switch outputs the measurement light through the first output port when in a first state, and the dual-polarization optical switch outputs the measurement light through the second output port when in a second state.

5. The LiDAR chip according to claim 4, wherein light split by the beam splitter is mixed with the local oscillator light and then transmitted to the receiver.

6. The LiDAR chip according to claim 4, wherein the dual-polarization grating coupler is a polarization-insensitive grating coupler, and a single port of the polarization-insensitive grating coupler is connected to the dual-polarization optical switch, and the polarization-insensitive grating coupler outputs received light with TE and TM polarization states to the dual-polarization optical switch.

7. The LiDAR chip according to claim 4, wherein the dual-polarization grating coupler is a polarization beam-splitting grating, the transmitter further comprises a polarization beam combiner, both ports of the polarization beam-splitter grating are connected to the polarization beam combiner, the polarization beam combiner is connected to the dual-polarization optical switch, the dual polarization grating coupler converts received light with TE and TM polarization states into TE polarized light and transmits the TE polarized light to the polarization beam combiner, and the polarization beam combiner performs polarization beam combining on the two TE polarized light beams and outputs the TE and TM polarized light to the dual-polarization optical switch.

8. The LiDAR chip according to claim 4, wherein the dual-polarization optical switch is a phase-change material optical switch.

9. The LiDAR chip according to claim 8, wherein the phase-change material optical switch is in the first state/second state when a phase-change material is in a crystalline state, the phase-change material optical switch is in the second state/first state when the phase-change material is in an amorphous state, and a switching control method of the crystalline state and the amorphous state of the phase-change material comprises external electrode heating, laser pulse stimulation, or electric pulse stimulation.

10. The LiDAR chip according to claim 1, wherein the LiDAR chip is further provided with electrical contact points electrically connected to an external processor, wherein the electrical contact points are electrically connected to the receiver and the optical switches.

11. A LiDAR, comprising a housing, a laser arranged in the housing, a processor, a collimating lens system, and the LiDAR chip according to claim 1, the laser provides a laser signal for the LiDAR chip, the processor is configured to control operations of the laser and the LiDAR chip, and the collimating lens system guides light emitted by the LiDAR chip.

12. The LiDAR chip according to claim 2, wherein the LiDAR chip is further provided with electrical contact points electrically connected to an external processor, wherein the electrical contact points are electrically connected to the receiver and the optical switches.

13. The LiDAR chip according to claim 3, wherein the LiDAR chip is further provided with electrical contact points electrically connected to an external processor, wherein the electrical contact points are electrically connected to the receiver and the optical switches.

14. The LiDAR chip according to claim 4, wherein the LiDAR chip is further provided with electrical contact points electrically connected to an external processor, wherein the electrical contact points are electrically connected to the receiver and the optical switches.

15. The LiDAR chip according to claim 5, wherein the LiDAR chip is further provided with electrical contact points electrically connected to an external processor, wherein the electrical contact points are electrically connected to the receiver and the optical switches.

16. The LiDAR chip according to claim 6, wherein the LiDAR chip is further provided with electrical contact points electrically connected to an external processor, wherein the electrical contact points are electrically connected to the receiver and the optical switches.

17. The LiDAR chip according to claim 7, wherein the LiDAR chip is further provided with electrical contact points electrically connected to an external processor, wherein the electrical contact points are electrically connected to the receiver and the optical switches.

18. The LiDAR chip according to claim 8, wherein the LiDAR chip is further provided with electrical contact points electrically connected to an external processor, wherein the electrical contact points are electrically connected to the receiver and the optical switches.

19. The LiDAR chip according to claim 9, wherein the LiDAR chip is further provided with electrical contact points electrically connected to an external processor, wherein the electrical contact points are electrically connected to the receiver and the optical switches.
